(19) United States
(12) Patent Application Publication
(10) Pub. No.: US 2022/0284755 A1
(43) Pub. Date: Sep. 8, 2022

(54) MONEY DEPOSITING AND DISPENSING DEVICE AND PROGRAM

(71) Applicant: TOSHIBA TEC KABUSHIKI KAISHA, Tokyo (JP)

(72) Inventor: Yuji Yasui, Izunokuni Shizuoka (JP)

(21) Appl. No.: 17/546,087

(22) Filed: Dec. 9, 2021

(30) Foreign Application Priority Data
Mar. 5, 2021 (JP) 2021-035592

(51) Int. Cl. G07D 11/235; G07D 11/14; G07D 11/13; G07D 11/28

(52) U.S. Cl. CPC G07D 11/235; G07D 11/14; G07D 11/13; G07D 11/28; G07D 2211/00; G07D 2201/00

(57) ABSTRACT

A money depositing and dispensing device includes a storing unit, a conveying unit, a power-supply operation unit, a power-supply control unit, and a display control unit. The storing unit stores money. The conveying unit conveys the money. The power-supply operation unit receives operation concerning a power supply of the money depositing and dispensing device. If the power-supply operation unit receives the operation, on condition that the money conveyed by the conveying unit is absent, the power-supply control unit turns off the conveying unit. On condition that the conveying unit is conveying the money, the display control unit causes a display unit to display an image indicating a reason for not turning off the conveying unit.

### CROSS-REFERENCE TO RELATED APPLICATION

This application is based upon and claims the benefit of priority from Japanese Patent Application No. 2021-035592, filed on Mar. 5, 2021, the entire contents of which are incorporated herein by reference.

### FIELD

Embodiments described herein relate generally to a money depositing and dispensing device and a program.

### BACKGROUND

In a retail store such as a supermarket, a money depositing and dispensing device has been used for settlement. If money is deposited to a depositing port, the money depositing and dispensing device conveys the money to a storing unit. If there is change, the money depositing and dispensing device conveys the money from the storing unit to a discharge port. The money depositing and dispensing device stores a quantity of the money stored in the storing unit.

In the money depositing and dispensing device, in order to improve operability, a power switch is disposed in an easily visible place. Therefore, a user such as a store clerk sometimes presses the power switch in a hurry, for example, if a trouble occurs.

However, in the money depositing and dispensing device, if the money depositing and dispensing device is turned off during the conveyance of the money, a difference occurs between a calculated quantity of the money and a quantity of actually stored money. In this case, the user has to re-count the money stored in the money depositing and dispensing device.

### DESCRIPTION OF THE DRAWINGS

FIG. 1 is a perspective view illustrating an example of the exterior of a money depositing and dispensing device according to an embodiment.

FIG. 2 is a block diagram illustrating an example of a hardware configuration of the money depositing and dispensing device according to the embodiment.

FIG. 3 is a block diagram illustrating an example of a functional configuration of the money depositing and dispensing device according to the embodiment.

FIG. 4 is a flowchart illustrating an example of stop processing executed by the money depositing and dispensing device according to the embodiment.

### DETAILED DESCRIPTION

An aspect of embodiments is to provide, in order to solve the problems described above, a money depositing and dispensing device and a program that can reduce possibility of erroneously turning off a money depositing and dispensing device.

A money depositing and dispensing device according to an embodiment includes a storing unit, a conveying unit, a power-supply operation unit, a power-supply control unit, and a display control unit. The storing unit stores money. The conveying unit conveys the money. The power-supply operation unit receives operation concerning a power supply of the money depositing and dispensing device. If the power-supply operation unit receives the operation, on condition that the money conveyed by the conveying unit is absent, the power-supply control unit turns off the conveying unit. On condition that the conveying unit is conveying the money, the display control unit causes a display unit to display an image indicating a reason for not turning off the conveying unit.

An embodiment of a money depositing and dispensing device and a program is explained in detail below with reference to the accompanying drawings. The embodiment explained below is an embodiment of a money depositing and dispending device and a program and does not limit the configurations, the specifications, and the like of the money depositing and dispensing device and the program.

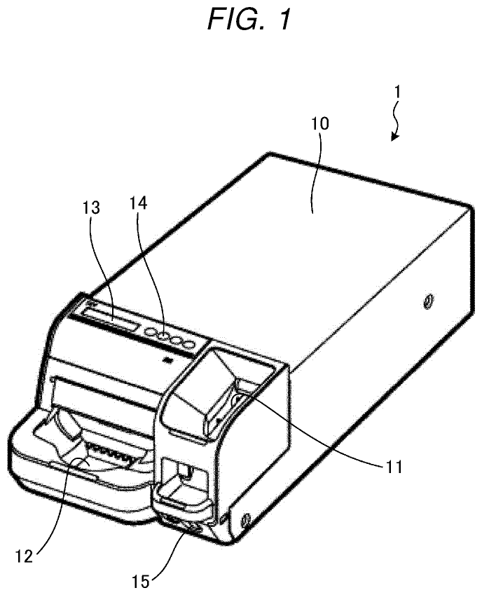

FIG. 1 is a perspective view illustrating an example of the exterior of a money depositing and dispensing device 1 according to this embodiment. The money depositing and dispensing device 1 illustrated in FIG. 1 is a device that executes depositing and dispensing of coins. For example, the money depositing and dispensing device 1 is connected to a POS (Point of Sales) terminal that executes commodity registration processing for registering a sales target commodity and checkout processing for paying a price of the commodity registered by the commodity registration processing.

The money depositing and dispensing device 1 includes a storage case 10 that covers a storing unit and a cassette. The storing unit stores money such as coins. The cassette is a container that temporarily stores the money in order to collect the money stored in the storing unit.

The money depositing and dispensing device 1 includes a depositing port 11 and a dispensing port 12 on a front surface. The depositing port 11 receives depositing of coins. The deposited coins are conveyed to the storing unit. The dispensing port 12 dispenses the coins stored in the storing unit.

The money depositing and dispensing device 1 includes a display unit 13 and an operation unit 14 on the front side of an upper surface. The display unit 13 displays a state of the money depositing and dispensing device 1. For example, the display unit 13 is a liquid crystal display. The operation unit 14 receives operation for the money depositing and dispensing device 1. For example, the operation unit 14 is an operation button.

The money depositing and dispensing device 1 includes a power switch 15 below the depositing port 11 on the front surface. The power switch 15 is a button for switching ON and OFF of power in the money depositing and dispensing device 1. The power switch 15 is a software switch controlled by software.

A hardware configuration of the money depositing and dispensing device 1 is explained.

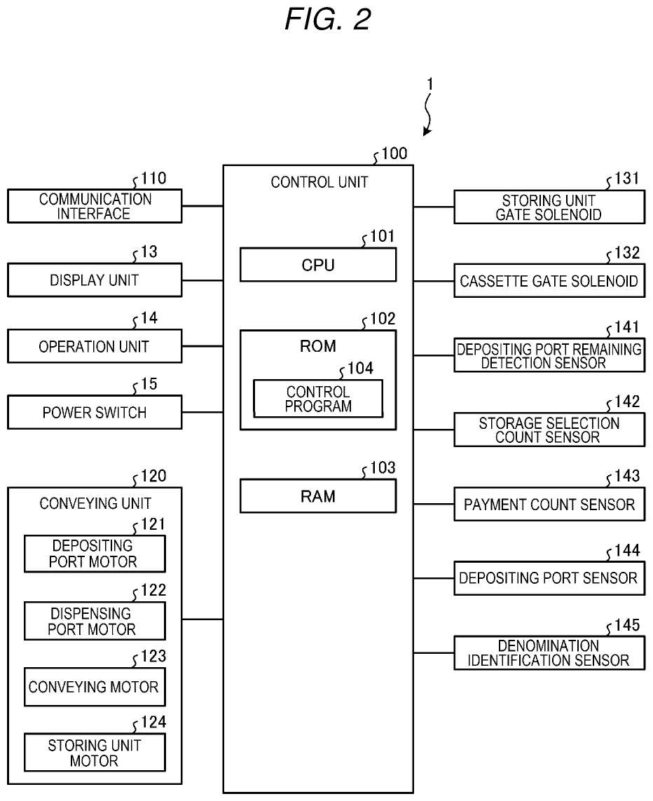

FIG. 2 is a block diagram illustrating an example of the hardware configuration of the money depositing and dispensing device 1 according to this embodiment. The money depositing and dispensing device 1 includes a control unit 100, a communication interface 110, the display unit 13, the operation unit 14, the power switch 15, a storing unit gate solenoid 131, a cassette gate solenoid 132, a dispensing port remaining detection sensor 141, a storage selection count sensor 142, a payment count sensor 143, a depositing port sensor 144, and a denomination identification sensor 145. These units are connected to the control unit 100 via a system bus such as a data bus or an address bus.

The control unit 100 is a computer that controls the operation of the entire money depositing and dispensing device 1 and realizes various functions of the money depositing and dispensing device 1. The control unit 100 includes a CPU (Central Processing Unit) 101, a ROM (Read Only Memory) 102, and a RAM (Random Access Memory) 103.

The CPU 101 collectively controls the operation of the money depositing and dispensing device 1. The ROM 102 is a storage medium from which various programs and various data can be read out. For example, the ROM 102 stores a control program 104. The control program 104 is an operating system or a program for exerting functions of the money depositing and dispensing device 1. The control program 104 includes a program for exerting a characteristic function according to this embodiment. The RAM 103 is a storage medium in which readout and writing of various programs and various data are executable. The CPU 101 executes a program stored in the ROM 102 or the like using the RAM 103 as a work area (a work region).

The RAM 103 includes a battery backup. That is, the RAM 103 can retain stored data even if the money depositing and dispensing device 1 is turned off. For example, the RAM 103 stores, for example, the numbers of pieces of money stored in the storing unit. The money depositing and dispensing device 1 may include, instead of the RAM 103 including the battery backup, an auxiliary storage device capable of retaining stored data even if electric power is not supplied such as a flash memory.

The communication interface 110 is an interface that executes communication with an external device such as a POS terminal to which the money depositing and dispensing device 1 is connected. For example, the communication interface 110 is an interface such as an RS (Recommended Standard)-232 or a USB (Universal Serial Bus).

A conveying unit 120 conveys money. The conveying unit 120 includes a depositing port motor 121, a dispensing port motor 122, a conveying motor 123, and a storing unit motor 124.

The depositing port motor 121 is a motor that drives a conveying belt provided in the depositing port 11. The depositing port motor 121 drives the conveying belt to convey money deposited to the depositing port 11 to a conveying path on the inside of the storage case 10. The dispensing port motor 122 is a motor that drives a conveying belt provided in the dispensing port 12. The dispensing port motor 122 drives the conveying belt to convey money from the conveying path on the inside of the storage case 10 to the dispensing port 12. The conveying motor 123 is a motor that drives the conveying belt provided in the conveying path on the inside of the storage case 10. The conveying motor 123 conveys the money in the conveying path. The storing unit motor 124 is a motor that drives a conveying belt provided in the storing unit on the inside of the storage case 10. The storing unit motor 124 conveys the money in the storing unit.

The storing unit gate solenoid 131 is a solenoid that opens and closes a partition provided in a taking-in and out port of the storing unit. The cassette gate solenoid 132 is a solenoid that opens and closes a partition provided in a taking-in and out port of the cassette.

The dispensing port remaining detection sensor 141 is a sensor that detects money remaining in the dispensing port 12. The dispensing port remaining detection sensor 141 is a magnetic sensor. The storage selection count sensor 142 is a sensor used for counting how many pieces of money of denominations are stored in the storing unit. The payment count sensor 143 is a sensor used for, if money is dispensed, counting the number of pieces of the dispensed money. The depositing port sensor 144 is a sensor that detects that money is deposited to the depositing port 11. The denomination identification sensor 145 is a sensor for identifying a denomination of the deposited money.

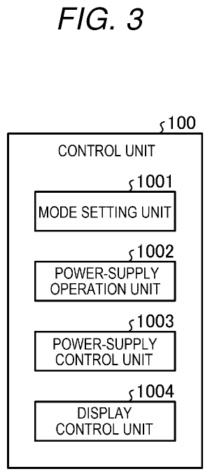

Functions of the money depositing and dispensing device 1 are explained. FIG. 3 is a block diagram illustrating an example of a functional configuration of the money depositing and dispensing device 1 according to this embodiment.

The CPU 101 included in the control unit 100 of the money depositing and dispensing device 1 loads, in the RAM 103, the control program 104 stored in the ROM 102 and operates according to the control program 104 to generate functional units in the RAM 103. Consequently, the control unit 100 of the money depositing and dispensing device 1 includes a mode setting unit 1001, a power-supply operation unit 1002, a power-supply control unit 1003, and a display control unit 1004 as the functional units.

The mode setting unit 1001 sets a mode concerning a power supply of the money depositing and dispensing device 1, which is an own device. The mode setting unit 1001 sets a power supply operation mode for stopping power supply to the money depositing and dispensing device 1 if the money depositing and dispensing device 1 is ON and the power switch 15 is pressed. The mode setting unit 1001 sets a power supply operation mode for stopping the power supply to the money depositing and dispensing device 1 if stop operation for stopping the power supply to the money depositing and dispensing device 1 is received. The power supply operation mode includes a ignoring mode, a first limitation mode, a second limitation mode, and an instant mode.

The ignoring mode is a mode for, if the power switch 15 is pressed during conveyance of money, ignoring processing for turning off the money depositing and dispensing device 1.

The first limitation mode is a mode for, if the power switch 15 is pressed during conveyance of money, after the conveyance of the money is completed, ignoring the processing for turning off the money depositing and dispensing device 1.

The second limitation mode is a mode for, if the power switch 15 is pressed during the conveyance of the money, after the conveyance of the money is completed, shifting the money depositing and dispensing device 1 to a power saving mode for stopping power supply to a part of the units of the money depositing and dispensing device 1. For example, in the case of the power saving state, the money depositing and dispensing device 1 supplies electric power to a warning buzzer that emits warning sound if the storing unit is opened and a recording unit that records a log if the storing unit is opened. It is possible to improve crime prevention capability by setting the money depositing and dispensing device 1 in the power saving state.

The instant mode is a mode for, if the power switch 15 is pressed during the conveyance of the money, executing processing for turning off the money depositing and dispensing device 1. That is, the instant mode is a mode for, without waiting for the completion of the conveyance of the money, executing processing for turning off the money depositing and dispensing device 1.

The power-supply operation unit 1002 receives operation concerning the power supply of the own device. For example, the power-supply operation unit 1002 receives the operation concerning the power supply based on pressing of the power switch 15.

More specifically, the power-supply operation unit 1002 receives forced shutdown operation for shutting down the own device. For example, if the power switch 15 is pressed in a state in which electric power is supplied, the power-supply operation unit 1002 receives the operation as the forced shutdown operation on condition that a pressing time of the power switch 15 is equal to or longer than a set time.

If the power switch 15 is pressed in the state in which electric power is supplied, the power-supply operation unit 1002 receives the operation as stop operation for stopping all or a part of the power supply to the own device if the pressing time of the power switch 15 is shorter than the set time.

If the power switch 15 is pressed in a state in which electric power is not supplied, the power-supply operation unit 1002 receives the operation as start operation for starting power supply to the own device and starting the own device.

The power-supply control unit 1003 controls power supply to the own device. States of the power supply to the money depositing and dispensing device 1 include a power saving state and an operation state. The power saving state is a state in which power supply to a part of the money depositing and dispensing device 1 is stopped. For example, in the power saving state, power supply to the conveying unit 120 is stopped. On the other hand, in the power saving state, electric power is supplied to the warning buzzer that emits warning sound if the storing unit is opened and the recording unit that records a log if the storing unit is opened. The operation state is a state in which the money depositing and dispensing device 1 is operable. That is, the operation state is a state in which the money depositing and dispensing device 1 is capable of executing depositing and dispensing of money.

If the power-supply operation unit 1002 receives stop operation, the power-supply control unit 1003 turns off the conveying unit 120 on condition that money conveyed by the conveying unit 120 is absent. More specifically, the power-supply control unit 1003 turns off the conveying unit 120 based on the setting of the power supply operation mode.

If the power-supply operation unit 1002 receives the stop operation in a state in which the power supply operation mode is set to the ignoring mode, the power-supply control unit 1003 ignores the operation received by the power-supply operation unit 1002 on condition that the conveying unit 120 is conveying money. That is, the power-supply control unit 1003 maintains the operation state. According to completion of the conveyance of the money by the conveying unit 120, the power-supply control unit 1003 turns off the own device on condition that money conveyed by the conveying unit 120 is absent.

If the power-supply operation unit 1002 receives the stop operation in a state in which the power supply operation mode is set to the first limitation mode, according to the completion of the conveyance of the money by the conveying unit 120, the power-supply control unit 1003 turns off the own device on condition that money conveyed by the conveying unit 120 is absent. That is, the power-supply control unit 1003 stays on standby until the conveyance of the money by the conveying unit 120 is completed. If the conveyance of the money by the conveying unit 120 is completed, the power-supply control unit 1003 shuts down the own device.

If the power-supply operation unit 1002 receives the stop operation in a state in which the power supply operation mode is set to the second limitation mode, according to the completion of the conveyance of the money by the conveying unit 120, the power-supply control unit 1003 turns off power supply to a part of the own device on condition that money conveyed by the conveying unit 120 is absent. That is, the power-supply control unit 1003 stays on standby until the conveyance of the money by the conveying unit 120 is completed. If the conveyance of the money by the conveying unit 120 is completed, the power-supply control unit 1003 changes the own device to the power saving state.

If the power-supply operation unit 1002 receives the stop operation in a state in which the power supply operation mode is set to the instant mode, the power-supply control unit 1003 shuts down the own device. That is, the power-supply control unit 1003 shuts down the own device even during the conveyance of the money by the conveying unit 120.

If the power-supply operation unit 1002 receives the forced shutdown operation, the power-supply control unit 1003 shuts down the own device even if money conveyed by the conveying unit 120 is present. If the conveyance of the money is completed, the money depositing and dispensing device 1 is likely to, because of a deficiency or the like, erroneously recognize that the conveyance of the money is not completed. In this case, if the power supply operation mode is set to the ignoring mode or the first limitation mode, the power-supply control unit 1003 cannot shut down the own device. Therefore, if the power-supply operation unit 1002 receives the forced shutdown operation, the power-supply control unit 1003 shuts down the own device even if the power supply operation mode is set to any mode. Consequently, the power-supply control unit 1003 prevents the money depositing and dispensing device 1 from being unable to be shut down.

The display control unit 1004 controls the display unit 13 to display various screens. More specifically, on condition that the conveying unit 120 is conveying money, the display control unit 1004 causes the display unit 13 to display an image indicating a reason for not turning off the money depositing and dispensing device 1. Consequently, a user can grasp a reason why the money depositing and dispensing device 1 is not turned off although the power switch 15 is pressed.

The image indicating the reason for not turning off the money depositing and dispensing device 1 may be, for example, a message indicating the reason for not turning off the money depositing and dispensing device 1, an icon indicating the reason for not turning off the money depositing and dispensing device 1, or an image of another form. The display control unit 1004 may display the image indicating the reason for not turning off the money depositing and dispensing device 1 on the display unit 13 in any form. For example, the display control unit 1004 may alternately switching to display an image currently being displayed and the image indicating the reason for not turning off the money depositing and dispensing device 1 or may display the image currently being displayed and the image indicating the reason for not turning off the money depositing and dispensing device 1 separately in two parts. The display control unit 1004 may cause a display of an external device such as a POS terminal connected via the communication interface 110 to display the image indicating the reason for not turning off the money depositing and dispensing device 1.

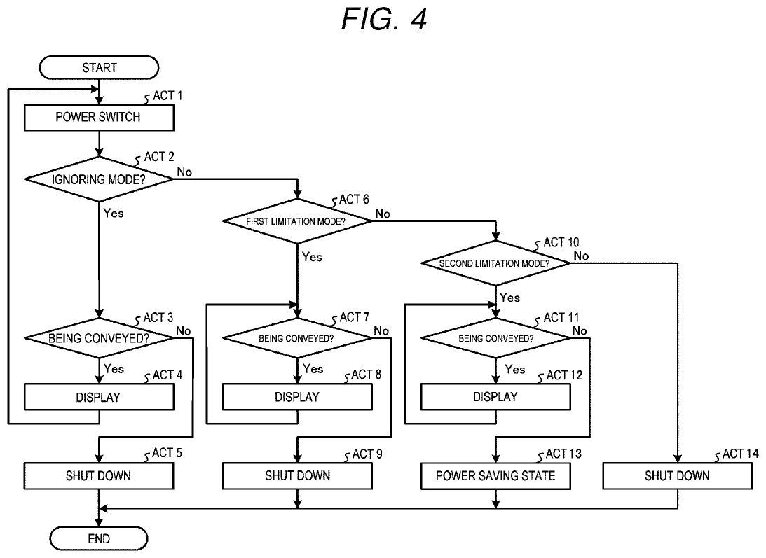

Stop processing executed by the money depositing and dispensing device 1 is explained. FIG. 4 is a flowchart illustrating an example of the stop processing executed by the money depositing and dispensing device 1 according to this embodiment.

The power-supply operation unit 1002 receives, from the power switch 15, stop operation for stopping power supply (Act 1).

The power-supply control unit 1003 determines whether the power supply operation mode is set to the ignoring mode (Act 2). If the power supply operation mode is set to the ignoring mode (Yes in Act 2), the power-supply control unit 1003 determines whether the conveying unit 120 is conveying money (Act 3).

If the conveying unit 120 is conveying money (Yes in Act 3), the display control unit 1004 causes the display unit 13 to display an image indicating a reason for not turning off the money depositing and dispensing device 1 (Act 4). Since the power supply operation mode is the ignoring mode, the display control unit 1004 may display that the stop operation is ignored. The money depositing and dispensing device 1 shifts to Act 1.

If the conveying unit 120 is not conveying money (No in Act 3), the power-supply control unit 1003 shuts down the money depositing and dispensing device 1 (Act 5). That is, the power-supply control unit 1003 stops the power supply to the money depositing and dispensing device 1.

If the power supply operation mode is not set to the ignoring mode (No in Act 2), the power-supply control unit 1003 determines whether the power supply operation mode is set to the first limitation mode (Act 6).

If the power supply operation mode is set to the first limitation mode (Yes in Act 6), the power-supply control unit 1003 determines whether the conveying unit 120 is conveying money (Act 7).

If the conveying unit 120 is conveying money (Yes in Act 7), the display control unit 1004 causes the display unit 13 to display an image indicating a reason for not turning off the money depositing and dispensing device 1 (Act 8). Since the power supply operation mode is the first limitation mode, the display control unit 1004 may display that shutdown is executed after the conveyance of the money by the conveying unit 120 is completed. The money depositing and dispensing device 1 shifts to Act 7.

If the conveying unit 120 is not conveying money (No in Act 7), the power-supply control unit 1003 shuts down the money depositing and dispensing device 1 (Act 9). That is, the power-supply control unit 1003 stops the power supply to the money depositing and dispensing device 1.

If the power supply operation mode is not set to the first limitation mode (No in Act 6), the power-supply control unit 1003 determines whether the power supply operation mode is set to the second limitation mode (Act 10).

If the power supply operation mode is set to the second limitation mode (Yes in Act 10), the power supply control unit 1003 determines whether the conveying unit 120 is conveying money (Act 11).

If the conveying unit 120 is conveying money (Yes in Act 11), the display control unit 1004 causes the display unit 13 to display an image indicating a reason for not turning off the money depositing and dispensing device 1 (Act 12). Since the power supply operation mode is the second limitation mode, the display control unit 1004 may display that the money depositing and dispensing device 1 shifts to the power saving state after completion of the conveyance of the money by the conveying unit 120. The money depositing and dispensing device 1 shifts to Act 11.

If the conveying unit 120 is not conveying money (No in Act 11), the power-supply control unit 1003 changes the money depositing and dispensing device 1 to the power saving state (Act 13). That is, the power-supply control unit 1003 stops the power supply to the money depositing and dispensing device 1.

If the power supply operation mode is not set to the second limitation mode (No in Act 10), the power-supply control unit 1003 shuts down the money depositing and dispensing device 1 (Act 14). That is, since the power supply operation mode is the instant mode, the power-supply control unit 1003 stops the power supply to the money depositing and dispensing device 1 irrespective of whether money is being conveyed.

Then, the money depositing and dispensing device 1 ends the stop processing.

As explained above, if receiving the operation concerning the power supply of the own device, the money depositing and dispensing device 1 according to this embodiment turns off the conveying unit 120 on condition that money conveyed by the conveying unit 120 is absent. The money depositing and dispensing device 1 causes the display unit 13 to display, on condition that the conveying unit 120 is conveying money, an image indicating a reason for not turning off the money depositing and dispensing device 1. In this way, turn-off of the money depositing and dispensing device 1 is limited during the conveyance. Therefor, it is possible to reduce possibility of erroneously turning off the money depositing and dispensing device 1.

In the embodiment, the money depositing and dispensing device 1 is explained as being the device that executes depositing and dispensing of coins. However, the money depositing and dispensing device 1 may be a device that executes depositing and dispensing of not only the coins but also bills.

Several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

Programs to be executed by the devices in the embodiment and the modifications are provided while being incorporated in advance in storage media (ROMs or storing units) included in the devices but are not limited to this. For example, the programs may be provided while being recorded in a computer-readable recording medium such as a CD-ROM, a flexible disk (FD), a CD-R, or a DVD (Digital Versatile Disk) as a file of an installable format or an executable format. Further, the storage media are not limited to media independent from a computer or an incorporating system and include storage media in which programs transmitted by a LAN (Local Area Network), the Internet, or the like are downloaded and stored or temporarily stored.

The programs to be executed by the devices in the embodiment and the modifications may be stored on a computer connected to a network such as the Internet and provided by being downloaded through the network. The programs may be provided or distributed through the network such as the Internet.

What is claimed is:

1. A money depositing and dispensing device comprising:
a storing compartment configured to store money;
a conveying component configured to convey the money;
a power-supply operation component configured to receive operation concerning a power supply of the money depositing and dispensing device;
a power-supply controller configured to, if the power-supply operation component receives the operation, on condition that the money conveyed by the conveying component is absent, turn off the conveying component; and
a display controller configured to, on condition that the conveying component is conveying the money, cause a display to display an image indicating a reason for not turning off the conveying component.

2. The money depositing and dispensing device according to claim 1, wherein, according to completion of the conveyance of the money by the conveying component, the power-supply controller turns off the money depositing and dispensing device on condition that the money conveyed by the conveying component is absent.

3. The money depositing and dispensing device according to claim 1, wherein, according to completion of the conveyance of the money by the conveying component, the power-supply controller turns off power supply to a part of the money depositing and dispensing device on condition that the money conveyed by the conveying component is absent.

4. The money depositing and dispensing device according to claim 1, further comprising a setting component configured to set a mode concerning the power supply of the money depositing and dispensing device, wherein
the power-supply controller turns off the money depositing and dispensing device based on the mode.

5. The money depositing and dispensing device according to claim 1, wherein the power-supply operation component receives forced shutdown operation for shutting down the money depositing and dispensing device and, if the power-supply operation component receives the forced shutdown operation, shuts down the money depositing and dispensing device even if the money conveyed by the conveying component is present.

6. The money depositing and dispensing device according to claim 1, further comprising:
a communication interface that executes communication with a point of sale terminal.

7. A method for a money depositing and dispensing device including a storing component configured to store money and a conveying component configured to convey the money, the method comprising:
receiving operation concerning a power supply of the money depositing and dispensing device;
if the power-supply operation component receives the operation, on condition that the money conveyed by the conveying unit is absent, turning off the conveying component; and
on condition that the conveying component is conveying the money, causing a display to display an image indicating a reason for not turning off the conveying component.

8. The method according to claim 7, further comprising:
according to completion of the conveyance of the money by the conveying component, turning off the money depositing and dispensing device on condition that the money conveyed by the conveying component is absent.

9. The method according to claim 7, further comprising:
according to completion of the conveyance of the money by the conveying component, turning off power supply to apart of the money depositing and dispensing device on condition that the money conveyed by the conveying component is absent.

10. The method according to claim 7, further comprising:
setting a mode concerning the power supply of the money depositing and dispensing device; and
turning off the money depositing and dispensing device based on the mode.

11. The method according to claim 7, further comprising:
receiving forced shutdown operation for shutting down the money depositing and dispensing device and, if the power-supply operation component receives the forced shutdown operation, shutting down the money depositing and dispensing device even if the money conveyed by the conveying component is present.

12. The method according to claim 7, further comprising:
communicating with a point of sale terminal.

13. A money handling device comprising:
a money depositing port;
a money dispensing port;
a storing compartment configured to store money;
a conveying component configured to convey the money;
a power-supply operation component configured to receive operation concerning a power supply of the money depositing and dispensing device;
a power-supply controller configured to, if the power-supply operation component receives the operation, on condition that the money conveyed by the conveying component is absent, turn off the conveying component; and
a display controller configured to, on condition that the conveying component is conveying the money, cause a display to display an image indicating a reason for not turning off the conveying component.

14. The money handling device according to claim 13, wherein, according to completion of the conveyance of the money by the conveying component, the power-supply controller turns off the money handling device on condition that the money conveyed by the conveying component is absent.

15. The money handling device according to claim 13, wherein, according to completion of the conveyance of the money by the conveying component, the power-supply controller turns off power supply to apart of the money handling device on condition that the money conveyed by the conveying component is absent.

16. The money handling device according to claim 13, further comprising a setting component configured to set a mode concerning the power supply of the money handling device, wherein
the power-supply controller turns off the money handling device based on the mode.

17. The money handling device according to claim 13, wherein the power-supply operation component receives forced shutdown operation for shutting down the money handling device and, if the power-supply operation component receives the forced shutdown operation, shuts down the money handling device even if the money conveyed by the conveying component is present.

18. The money handling device according to claim 13, further comprising:
a communication interface that executes communication with a point of sale terminal.

19. The money handling device according to claim 13, wherein the money depositing port comprises a first money depositing port for bills and a second money depositing port for coins.

20. The money handling device according to claim 13, wherein the money dispensing port comprises a first money dispensing port for bills and a second money dispensing port for coins.
